(19) United States
(12) Patent Application Publication
(10) Pub. No.: US 2026/0196596 A1
(43) Pub. Date: Jul. 9, 2026

(54) BATTERY PACK DIVIDER ASSEMBLY WITH MULTIPLE FINS

(71) Applicant: Ford Global Technologies, LLC, Dearborn, MI (US)

(72) Inventors: Pradeep Elumalai, Northville, MI (US); Jie Deng, Novi, MI (US); Sangyeon Kim, Northville, MI (US)

(21) Appl. No.: 19/009,046

(22) Filed: Jan. 3, 2025

(51) Int. Cl. H01M 10/6551; H01M 10/613; H01M 10/625; H01M 10/6555; H01M 10/6567; H01M 10/658

(52) U.S. Cl. CPC H01M 10/6551; H01M 10/613; H01M 10/625; H01M 10/6555; H01M 10/6567; H01M 10/658

(57) ABSTRACT

A traction battery pack assembly includes a cell stack within an interior of an enclosure assembly. The cell stack includes a plurality of battery cells disposed along a cell stack axis and at least one divider assembly, which has at least two fins that are joined together. The at least two fins can each have a C-shaped cross-sectional profile.

### TECHNICAL FIELD

This disclosure details exemplary divider assemblies for a battery pack, and more particularly, to divider assemblies having multiple fins that are joined together.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: a cell stack within an interior of an enclosure assembly, the cell stack including a plurality of battery cells disposed along a cell stack axis and at least one divider assembly having at least two fins that are joined together.

In some aspects, the techniques described herein relate to an assembly, wherein the at least two fins includes a first fin and a second fin.

In some aspects, the techniques described herein relate to an assembly, wherein the at least two fins each have a C-shaped cross-sectional profile.

In some aspects, the techniques described herein relate to an assembly, wherein the at least two fins each have a divider section, and at least one support section extending transversely from the divider section.

In some aspects, the techniques described herein relate to an assembly, wherein the at least one support section includes a first support section bonded to an enclosure assembly on a first side of the plurality of battery cells, and a second support section bonded to the enclosure assembly on an opposite, second side of the plurality of battery cells.

In some aspects, the techniques described herein relate to an assembly, wherein the first support section is bonded to an enclosure cover of the enclosure assembly, and the second support section is bonded to an enclosure tray of the enclosure assembly.

In some aspects, the techniques described herein relate to an assembly, wherein the at least two fins includes a first fin and a second fin, the first fin having a first fin divider section and at least one first fin support section extending transversely from the first fin divider section in a first axial direction, the second fin having a second fin divider section and at least one second fin support section extending from the second fin divider section in an opposite, second axial direction.

In some aspects, the techniques described herein relate to an assembly, wherein the first fin divider section is welded to the at least one first fin support section, wherein the second fin divider section is welded to the at least one second fin support section.

In some aspects, the techniques described herein relate to an assembly, wherein the first fin divider section is received within a groove of the at least one first fin support section, wherein the second fin divider section is received within a groove of the at least one second fin support section.

In some aspects, the techniques described herein relate to an assembly, wherein the at least two fins each axially overlap over at least one battery cell within the plurality of battery cells.

In some aspects, the techniques described herein relate to an assembly, wherein the at least two fins are stamped metal or stamped metal-alloy.

In some aspects, the techniques described herein relate to an assembly, wherein the at least two fins are aluminum.

In some aspects, the techniques described herein relate to an assembly, wherein the at least two fins are welded together.

In some aspects, the techniques described herein relate to an assembly, wherein the at least one divider assembly supports the plurality of battery cells in an elevated position where the plurality of battery cells are spaced from the enclosure assembly.

In some aspects, the techniques described herein relate to an assembly, wherein the cell stack is at least partially immersed in a liquid coolant.

In some aspects, the techniques described herein relate to an assembly, wherein the cell stack is immersion cooled.

In some aspects, the techniques described herein relate to an assembly, further including a plurality of thermal barriers of the at least one divider assembly, the at least two fins sandwiched between the plurality of thermal barriers along the cell stack axis.

In some aspects, the techniques described herein relate to an assembly, further including a plurality of compressible layers of the at least one divider assembly, the at least two fins and the plurality of thermal barriers sandwiched between the plurality of compressible layers.

In some aspects, the techniques described herein relate to a traction battery pack assembly, including: an enclosure assembly; and a cell stack within an interior of the enclosure assembly, the cell stack including a plurality of battery cells supported within the interior by a plurality of divider assemblies, the plurality of divider assemblies each including at least two fins that are secured together.

In some aspects, the techniques described herein relate to an assembly, wherein the at least two fins is at least two c-shaped fins that are each bonded to the enclosure assembly on a first side of the cell stack and bonded to the enclosure assembly on an opposite, second side of the cell stack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1.

FIG. 3 illustrates an expanded view of the battery pack of FIG. 2.

FIG. 4 illustrates a section view taken at line 4-4 in FIG. 2.

FIG. 5 illustrates a closeup view of an area in FIG. 4.

FIG. 6 illustrates a closeup view of another area in FIG. 4.

FIG. 7 illustrates a closeup view of the area of FIG. 5 showing a divider assembly according to another exemplary aspect of the present disclosure.

FIG. 8 illustrates the area of FIG. 5 showing a divider assembly according to yet another exemplary aspect of the present disclosure.

### DETAILED DESCRIPTION

A traction battery pack can include a cell stack. Some cell stacks incorporate divider assemblies to compartmentalize cells of the cell stack and manage thermal energy within the battery pack. Some divider assemblies can help to support the cell stack within an enclosure assembly.

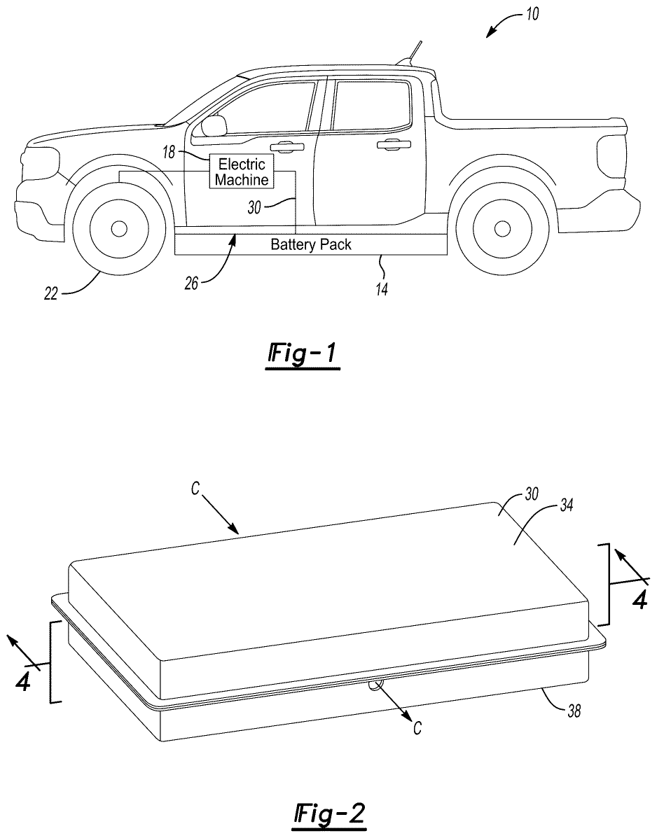

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

FIGS. 2-4 illustrate additional details of the battery pack 14. In this example, the battery pack 14 includes an enclosure assembly 30. The enclosure assembly 30 includes a cover 34 and a tray 38. The cover 34, in this example, is vertically above the tray 38. In other examples, however, the cover 34 could be arranged below, or to a side of the tray 38.

Various terms such as “vertical,” “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1,

The cover 34 is welded to the tray 38 in one example of this disclosure. While welding is mentioned, the cover 34 and tray 38 could be connected in other ways, such as by using an adhesive. Further, while an exemplary enclosure assembly 30 is shown in the drawings, the enclosure assembly 30 may vary in size, shape, and configuration within the scope of this disclosure.

In this disclosure, a cell stack 42 is arranged within an interior of the enclosure assembly 30. The example cell stack 42 includes a plurality of individual battery cells 46 disposed along a cell stack axis A, and a plurality of divider assemblies 50. Each of the divider assemblies 50 can be sandwiched between two of the battery cells 46 along the cell stack axis.

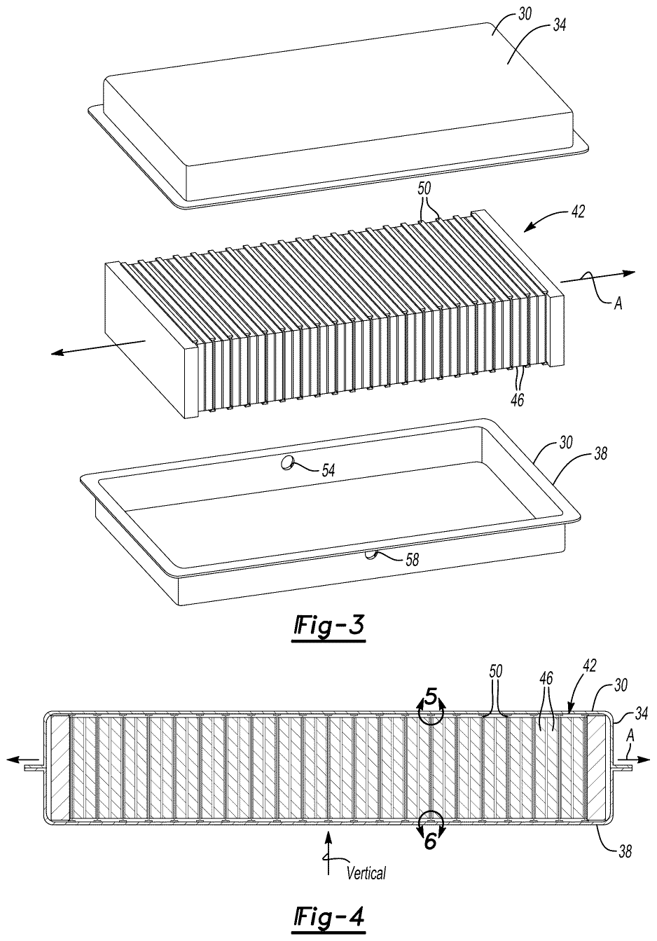

The battery pack 14 could employ any number of cell stacks 42 within the enclosure assembly 30. The cell stack 42 could include any number of battery cells 46. Thus, this disclosure is not limited to the exact configuration shown in FIGS. 2 to 4. Further, while the battery cells 46 and the divider assemblies 50 of FIG. 3 are positioned horizontally side-by-side relative to one another, other configurations are also contemplated within the scope of this disclosure, including but not limited to embodiments in which the battery cells 46 and divider assemblies 50 are stacked on top of one another, for example.

In an embodiment, the battery cells 46 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The cell stack 42 is arranged in the interior of the enclosure assembly 30 between the tray 38 and the cover 34. A thermal management system is used to manage thermal energy levels within the battery pack 14. The example thermal management system is configured to route non-conductive (i.e., dielectric), liquid coolant C over areas of the cell stack 42 to manage thermal energy within the cell stack 42 by, for example, using the coolant C to take on heat from the cell stack 42 to cool the cell stack 42. The thermal management system is an immersion thermal management system at least because portions of the battery pack 14, here at least the battery cells 46 of the cell stack 42 are immersed in the coolant C.

In this example, the coolant C generally flows from an inlet 54 to an outlet 58. The inlet 54 extends through the tray 38 on a first side of the cell stack 42. The outlet 58 extends through the tray 38 on an opposite, second side of the cell stack 42.

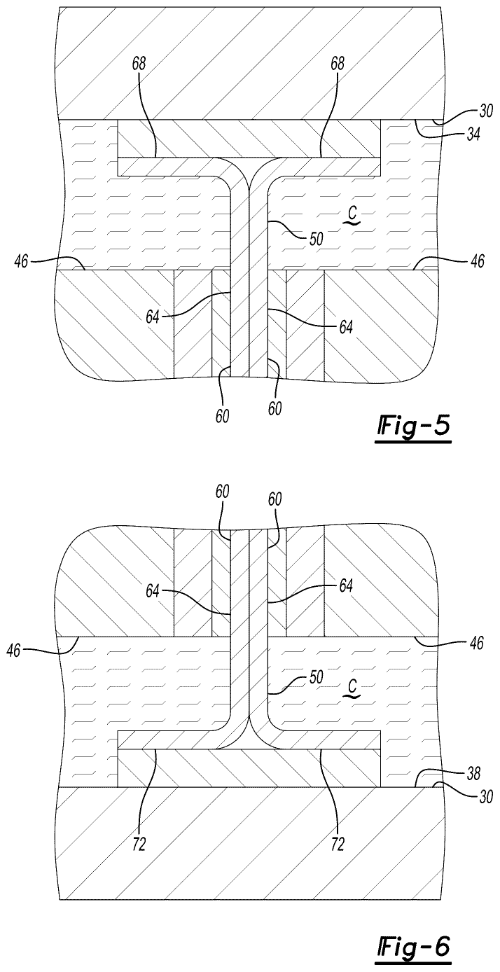

With reference now to FIGS. 5 and 6, and continuing reference to FIGS. 2-4, the divider assemblies 50 can be used to support the cell stack 42 within the interior of the enclosure assembly 30. The divider assemblies 50 support, in this example, the cell stack 42 such that coolant C can communicate below the battery cells 46 and above the battery cells 46.

The example divider assemblies 50 each include at least two fins 60. In this example, each of the divider assemblies 50 include two fins 60. Each of the example fins has a C-shaped cross-sectional profile. In the divider assemblies, the fins 60 are placed adjacent to each other and joined such that one of the fins 60 having the C-shaped cross-sectional profile opens in a first axial direction, and the other fin 60 opens in an opposite, second axial direction.

The fins 60 each have a divider section 64, an upper support section 68, and a lower support section 72. The upper support section 68 extends transversely from the divider section 64 on a first side, here an upper side, of the cell stack 42. The lower support section 72 extends transversely from the divider section 64 on a second side of the cell stack 42, which is a lower side of the cell stack 42. The upper support sections 68 and the lower support sections 72 extend horizontally in this example and overlap horizontally with at least a portion of one of the battery cells 46 of the cell stack 42.

The fins 60 can span from a floor of the tray 38 to the cover 34. The upper support sections 68 are secured to the cover 34 and the lower support sections 72 are secured to the tray 38. Thermal energy can pass from the battery cells 46, through the fins 60, to the enclosure assembly 30.

The fins 60 can be bonded directly to the tray 38 and the cover 34 utilizing adhesive, for example. The fins 60 of the divider assemblies 50 support the cell stack 42 within the interior of the enclosure assembly 30 such that the cells 46 are elevated and spaced from the floor of the tray 38 and the cover 34.

When joined, the fins 60 have an I-shaped cross-sectional profile. The divider sections 64 combine to give the divider assembly 50 a double thickness where the divider assembly 50 extends through the cell stack 42, and a single thickness where the divider assembly 50 meets the cover 34 and the tray 38. The I-shape can facilitate strengthening the divider assembly 50 for tensile loading.

Each of the fins 60 can be a metal or metal-alloy. In this example, the fins 60 are aluminum.

The fins 60 can be stamped to provide the C-shaped profile. After stamping, the fins 60 can be joined within each of the divider assemblies 50. The fins 60 of each of the divider assemblies 50 can be welded together.

In this example, the divider assemblies 50 each include, in addition to the fins 60, thermal barriers 80. The fins 60 of each of the divider assemblies 50 are sandwiched between thermal barriers 80 along the cell stack axis A in this example. The thermal barriers 80 are placed directly against each of the fins 60 within a given one of the divider assemblies 50. The thermal barriers 80 can be mica sheets.

Each of the divider assemblies 50 additionally include compressible layers 84. The fins 60 and thermal barriers 80 are, in this example, sandwiched between two compressible layers 84. In an example, the compressible layers 84 are foam. The compressible layers 84 can help the divider assemblies 50 accommodate expansion of the cells 46 along the axis A.

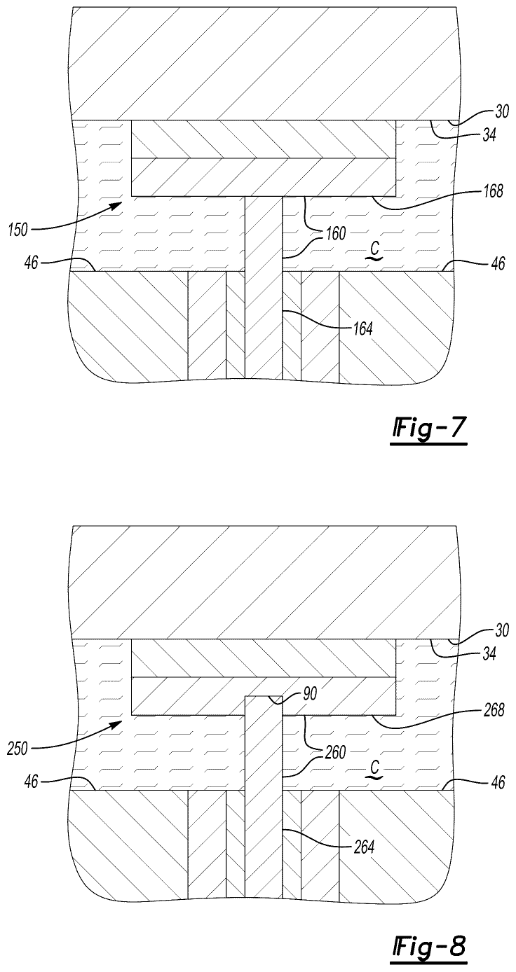

With reference now to FIG. 7, fins 160 of another example divider assembly 150 can include an upper support section 168 that is separate from a divider section 164. The upper support section 168 can be welded to the divider section 164 to provide the divider assembly 150 with a fin having an I-shape. A lower support section (not shown) can be similarly secured to a lower side of the divider section 164.

With reference to FIG. 8, yet another example fin 260 for use within a divider assembly 250 includes an upper support section 268 establishing a groove 90 that receives an upper end portion of a divider section 264. A lower support section (not shown) can include another groove that receives an opposite end portion of the divider section 264.

The divider section 264 can be welded or otherwise secured to the upper support section 268 to provide the divider assembly 230 with fins having an I-shaped cross-sectional profile. Receiving the divider section 264 within the groove 90 can help to position the divider assembly 230 along the cell stack axis A.

Features of the disclosed examples include a divider assembly having fins that can help to support a cell stack within an enclosure assembly. In some examples, the fins can be stamped, which can simplify manufacturing when compared to fins that are, for example, extruded fins. The fins could be assembled from multiple separate pieces in other examples.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a cell stack within an interior of an enclosure assembly, the cell stack including a plurality of battery cells disposed along a cell stack axis and at least one divider assembly having at least two fins that are joined together.

2. The assembly of claim 1, wherein the at least two fins comprises a first fin and a second fin.

3. The assembly of claim 1, wherein the at least two fins each have a C-shaped cross-sectional profile.

4. The assembly of claim 1, wherein the at least two fins each have a divider section, and at least one support section extending transversely from the divider section.

5. The assembly of claim 4, wherein the at least one support section comprises a first support section bonded to an enclosure assembly on a first side of the plurality of battery cells, and a second support section bonded to the enclosure assembly on an opposite, second side of the plurality of battery cells.

6. The assembly of claim 5, wherein the first support section is bonded to an enclosure cover of the enclosure assembly, and the second support section is bonded to an enclosure tray of the enclosure assembly.

7. The assembly of claim 1, wherein the at least two fins comprises a first fin and a second fin, the first fin having a first fin divider section and at least one first fin support section extending transversely from the first fin divider section in a first axial direction, the second fin having a second fin divider section and at least one second fin support section extending from the second fin divider section in an opposite, second axial direction.

8. The assembly of claim 7, wherein the first fin divider section is welded to the at least one first fin support section, wherein the second fin divider section is welded to the at least one second fin support section.

9. The assembly of claim 7, wherein the first fin divider section is received within a groove of the at least one first fin support section, wherein the second fin divider section is received within a groove of the at least one second fin support section.

10. The assembly of claim 1, wherein the at least two fins each axially overlap over at least one battery cell within the plurality of battery cells.

11. The assembly of claim 1, wherein the at least two fins are stamped metal or stamped metal-alloy.

12. The assembly of claim 1, wherein the at least two fins are aluminum.

13. The assembly of claim 1, wherein the at least two fins are welded together.

14. The assembly of claim 1, wherein the at least one divider assembly supports the plurality of battery cells in an elevated position where the plurality of battery cells are spaced from the enclosure assembly.

15. The assembly of claim 1, wherein the cell stack is at least partially immersed in a liquid coolant.

16. The assembly of claim 1, wherein the cell stack is immersion cooled.

17. The assembly of claim 1, further comprising a plurality of thermal barriers of the at least one divider assembly, the at least two fins sandwiched between the plurality of thermal barriers along the cell stack axis.

18. The assembly of claim 17, further comprising a plurality of compressible layers of the at least one divider assembly, the at least two fins and the plurality of thermal barriers sandwiched between the plurality of compressible layers.

19. A battery pack assembly, comprising:
an enclosure assembly; and
a cell stack within an interior of the enclosure assembly, the cell stack including a plurality of battery cells supported within the interior by a plurality of divider assemblies, the plurality of divider assemblies each including at least two fins that are secured together.

20. The assembly of claim 19, wherein the at least two fins is at least two c-shaped fins that are each bonded to the enclosure assembly on a first side of the cell stack and bonded to the enclosure assembly on an opposite, second side of the cell stack.
